(19) United States
(12) Patent Application Publication
(10) Pub. No.: US 2008/0169360 A1
(43) Pub. Date: Jul. 17, 2008

(54) Volatile Liquid Dessemination Apparatus

(75) Inventors: Colin Brown, Bracknell Berkshire (GB); Guy Edward Naish, Bicester Oxfordshire (GB); Kishen Gohil, New Malden Surrey (GB)

Correspondence Address: NORRIS, MCLAUGHLIN & MARCUS, 875 THIRD AVE, 18TH FLOOR, NEW YORK, NY, 10022, US

(73) Assignee: GIVAUDAN SA, Vernier (CH)

(21) Appl. No.: 11/817,841

(22) PCT Filed: Mar. 8, 2006
(86) PCT No.: PCT/CH2006/000142

§ 371 Date: Oct. 30, 2007

(30) Foreign Application Priority Data
Mar. 15, 2005 (GB) 0505173.5

(51) Int. Cl. B05B 7/26

(52) U.S. Cl. 239/316

(57) ABSTRACT

An apparatus adapted to disseminate individually into an atmosphere a plurality of liquids, such as fragrances, the apparatus comprising
(i) a source of forced ventilation;
(ii) extending radially from the source, a plurality of passages, each having an entrance and an exit for the forced ventilation, the exit leading to the atmosphere; and
(iii) at or near the exit of each passage an evaporative source of volatile liquid; the apparatus additionally comprising a movable barrier that surrounds the source, this barrier having one port that is movable into correspondence with a single passage at a time, such that forced ventilation flows down only that passage.

This invention relates to apparatus for the dissemination of volatile liquid into an atmosphere.

Apparatus for the dissemination of volatile liquid, such as fragrance, malodour counteractant, insecticide, fungicide, and so on, are very well known and many types are available. Most of these are for single liquids, and typically comprise reservoirs of volatile liquid from which extends into the atmosphere a porous transport element, typically a porous wick. The liquid can be disseminated by unassisted evaporation from the surface of the transport element, or evaporation can be assisted by means of a fan, a heating element, or other such means.

A problem remaining in the art is the individual dissemination from a single apparatus of a plurality of liquids. An example of circumstances in which such an apparatus would be desirable is when it is desired to disseminate a number of fragrances, a different one in each of a number of time periods. Another example is the desirability of disseminating fragrance at one time and, say, insecticide at another. Apparatus that can do this do exist, but they tend to be complicated and expensive. Typically, such devices employ a multiple fragrance cartridge which is rotated or moved with respect to the method of dissemination, for example, a heating element or fan.

Apparatus that disseminate more than one fragrance are known, and typical examples may be found in International Application WO 2003/028775 and UK published application GB 2 401 047. However, both of these apparatus require fans that are reversible. Moreover, both are limited by their nature to the dissemination of two fragrances

It has now been found that it is possible to provide a simple, effective apparatus that can disseminate a plurality of volatile liquids into an atmosphere in a desired order. The invention therefore provides an apparatus adapted to disseminate individually into an atmosphere a plurality of liquids, the apparatus comprising
(i) a source of forced ventilation;
(ii) extending radially from the source, a plurality of passages, each having an entrance and an exit for the forced ventilation, the exit leading to the atmosphere; and
(iii) at or near the exit of each passage an evaporative source of volatile liquid; the apparatus additionally comprising a movable barrier that surrounds the source, this barrier having one port that is movable into correspondence with a single passage at a time, such that forced ventilation flows down only that passage.

The invention additionally provides a method of providing in an atmosphere one of a number of available volatile liquids by causing a gas to flow past a surface bearing one volatile liquid, thus causing evaporation thereof, each surface being located at an exit remote from a source of forced ventilation at the end of a passage extending radially from the source, the forced ventilation being directed solely into that passage by means of a movable barrier having a port that is brought into correspondence uniquely with an entrance of that passage.

The source of forced ventilation can be any such source that causes sufficient movement of gas to cause evaporation of volatile liquid. For example, it can be a piped gas. However, it is preferably a fan or impeller that rotates and causes air to move. The fan or impeller rotates continuously in one direction.

The passages may be provided by any convenient means. They are arranged radially from the source and are preferably equidistant from each other. The number of passages is not critical, and it can be tailored to however many liquids it is desired to disseminate. However, the number is preferably at least 3, more preferably at least 4. Six passages is readily achievable and is practical; higher numbers are possible, but they become less practical. A typical apparatus comprises a housing having a central portion to accommodate a fan, with the passages radiating from it in the plane of rotation of the fan. Such a housing may be made by any means and from any suitable material, moulding from plastics being a particularly useful method, although metals, ceramics, etc, can also be used.

At or near the exit of each passage, remote from the source of forced ventilation, is an evaporative source of volatile liquid, placed so that the forced ventilation will cause evaporation of the liquid and its dissemination into the atmosphere. The source may be any suitable source, examples including porous transport members such as wicks and gels. In a preferred embodiment, the source of volatile liquid is a reservoir comprising a wick that protrudes into the forced ventilation, reservoir and wick being part of a single replaceable unit. Replacement and/or change of liquid are therefore easy.

The movable barrier has the function of directing the forced ventilation through a particular passage to the exclusion of all others. It surrounds the ventilation source completely, except for one port, which is aligned to the entrance of a particular channel. The forced ventilation therefore blows down that passage only. The barrier can take any convenient form. For example, it may be cylindrical. It is preferably rotatable into any desired position.

Movement of the barrier may be effected manually or automatically. For example, the barrier may be aligned to a different passage manually by simply placing it in or rotating it to a different position. A rotatable barrier is preferred, as it allows for the possibility of simple automatic rotation. This can be achieved by any convenient means, such as a motor, which can be clockwork or (preferably) electric, the latter being powered by mains electricity, batteries, solar panels or any other convenient means. The motor may work intermittently or continuously; in the latter case, a system of reduction gearing may be employed. The skilled person can easily provide that a barrier rotate at a particular speed such that certain passages are opened to forced ventilation at desired times. Thus, for example, the barrier may be driven by an electric motor by any convenient means, such as drive band, chain idler wheel and reduction gearing. In another example, the barrier is moved rapidly from one position to another by means of a timer circuit and a stepper-motor designed to give fractions of a rotation on each operation.

In a preferred embodiment, the drive is by means of reduction gearing powered from the same motor that drives the fan. This has an advantage that a single motor can be used to drive both the fan and rotational mechanism, resulting in a much simpler and cheaper apparatus than those with rotating refills requiring separate motors.

In a further embodiment of the invention, the barrier is augmented by a further movable barrier, this further barrier also being continuous with the exception of a single port and being adapted to seal those exits of the passages further from the source of forced ventilation, with the exception of the passage through which forced ventilation flows. This prevents the release of evaporable material under ambient conditions from the channels down which the forced ventilation is not directed.

Reduction gearing has the advantage that the rotation of the barrier can be timed to deliver forced ventilation and therefore evaporation to any given channel for a particular time. The calculation of the required gear ratios is well within the skill of the art. Timings may be changed either by replacement of the gear set or by a transmission system that permits the ratio of the set to be changed.

The apparatus according to the invention is easy and cheap to manufacture from common materials and components, it is rugged, reliable and versatile in use, and replenishment is quick, easy and mess-free.

The invention is now further described with reference to the accompanying drawings, which depict preferred embodiments and which are not intended to be limiting in any way on the scope of the invention.

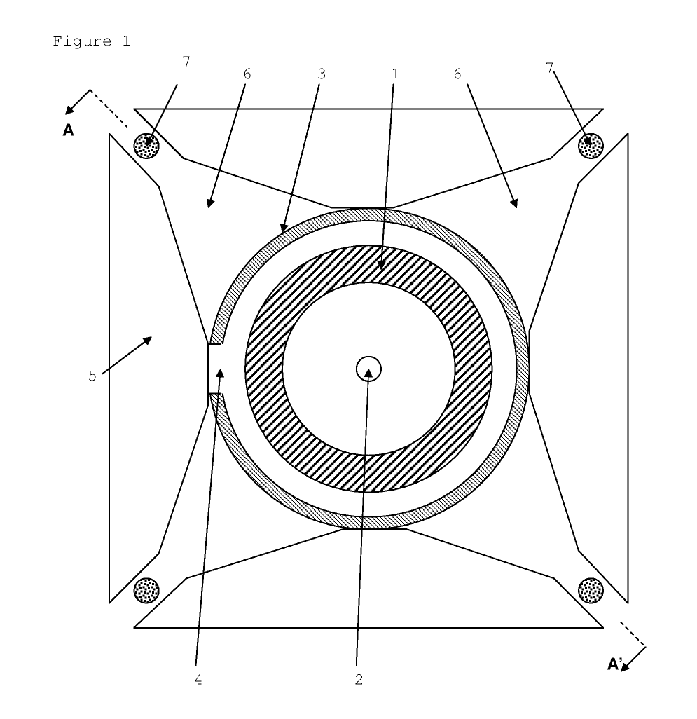

FIG. 1 depicts a schematic partial horizontal cross-section of an embodiment of the invention.

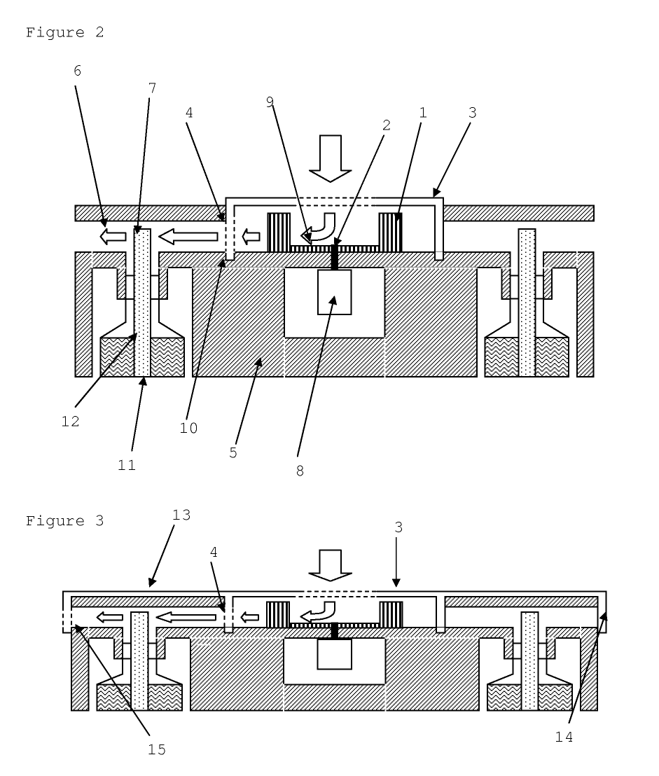

FIG. 2 depicts a schematic partial vertical cross-section along the line A-A′ of FIG. 1.

FIG. 3 depicts a schematic partial cross-section of a variation of the apparatus of FIGS. 1 and 2.

A centrifugal fan 1 is mounted on a motor spindle 2. Surrounding the centrifugal fan 1 is a barrier that essentially has the form of a rotatable cylinder 3 which has a single opening 4. The cylinder 3 and fan 1 are mounted on a unit 5. This is a moulded body, which provides a central location for the fan and the cylinder. Radiating from this central location is a plurality of passages 6. At the end of each passage remote from the fan is a wick 7. This extends from a reservoir 11, which contains a volatile liquid 12. The reservoir is fitted to the unit, so that it can be easily removed.

In FIG. 1, the cylinder opening 4 is facing a wall of the unit 5, against which it fits tightly, so no air escapes down the passage 6. In FIG. 2, the opening 4 has been moved so that it faces one of the passages 6.

Thus, in operation, the fan 1 draws in air (white arrows) through a port 9 in the top of the unit 5. Air is then blown through the cylinder opening 4 into the passage 6. At the end of the passage, it blows across and around the wick 7, and liquid is thus entrained into the air, which then passes out of the apparatus into the atmosphere.

In FIG. 3, the cylinder 3 having an opening 4 has incorporated therein a radial extension 13, which terminates in a further cylinder 14 concentric with cylinder 3, the cylinder 14 fitting sufficiently closely to the exterior of the unit 5 to prevent significant evaporation of volatile liquid from the wicks. The cylinder 14 also incorporates a port 15, this port being so positioned that, when port 4 of cylinder 3 is aligned with a passage, port 14 is aligned with the other end of that passage, so that forced ventilation can flow through the passage and out of the apparatus.

The skilled person will understand that many embodiments within the scope of this invention are possible. For example, the apparatus depicted in FIGS. 1 and 2 has a cylinder that is rotated by means of an electric motor. This can be replaced by a simpler manually-movable or -rotatable cylinder. The motorized version can be given any desired rotation period. The wicks and reservoirs depicted may be replaced by any other suitable source of volatile liquid, such as a fragrant gel. The source of liquid may be provided with heating means, to provide enhanced evaporation. The apparatus depicted in the drawings rely on the opening 4 being a tight fit against a wall of the unit for sealing. While no problem for low-power forced ventilation, it can be a problem for higher power. In such a case, the wall can be replaced by suitable ducting that directs the forced ventilation to the outside of the apparatus without passing through a wick-containing passage.

1. (canceled)

2. An apparatus according to claim 9 in which the source of forced ventilation is a fan or impeller that rotates in a single direction.

3. An apparatus according to claim 9, in which the source of volatile liquid is a reservoir comprising a wick that protrudes into the forced ventilation.

4. An apparatus according to claim 3, in which the reservoir and the wick form a single replaceable unit.

5. An apparatus according to claim 9, in which the movable barrier is cylindrical and rotatable into any desired position.

6. An apparatus according to claim 5, in which the source of forced ventilation is a fan or impeller driven by a motor and the rotation of the barrier is accomplished by means of reduction gearing powered from the same motor that drives the fan or impeller.

7. An apparatus according to claim 9, in which the movable barrier is augmented by a further movable barrier, this further barrier also being continuous with the exception of a single port and being adapted to seal those exits of the passages further from the source of forced ventilation, with the exception of the passage through which forced ventilation flows.

8. (canceled)

9. An apparatus adapted to disseminate individually into an atmosphere a plurality of volatile liquids, the apparatus comprising
(a) a base unit;
(b) a source of forced ventilation;
(c) a plurality of passages extending radially from the source of ventilation and are disposed in the base unit, each passage having an entrance and an exit, the entrance being connected to the source of forced ventilation, the exit leading to the atmosphere; and
(d) a plurality of evaporation sources of volatile liquid are disposed at or near the exit of each passage an evaporative;
(e) a movable barrier surrounding the source of forced ventilation having one port that is movable into correspondence with one of the plurality of the passages at a time, such that forced ventilation flows down into the corresponding passage.

10. A method of providing in an atmosphere one of a number of available volatile liquids comprising the steps of
(a) providing a plurality of volatile liquids and providing a surface bearing the volatile liquid for each of the volatile liquids,
(b) providing a source of forced ventilation,
(c) providing ventilation passage ways for directing the forced ventialtion,
(d) aligning one of the surface bearing volatile liquids with the ventilation passage way, causing evaporation of the surface bearing volatile liquid, each surface being located at an exit remote from a source of forced ventilation at the end of a passage extending radially from the source, the forced ventilation being directed solely into that passage by means of a movable barrier having a port that is brought into correspondence uniquely with an entrance of that passage.
